(19) United States
(12) Patent Application Publication
(10) Pub. No.: US 2005/0103701 A1
(43) Pub. Date: May 19, 2005

(54) Liquid filter arrangement with secondary filter and bypass flow

(75) Inventors: Keith Allan Bechtum, Richfield, MN (US); Brent Alan Gulsvig, Faribault, MN (US); David Wayne Mulder, Bloomington, MN (US); John R Hacker, Edina, MN (US)

Correspondence Address: MERCHANT & GOULD PC, P.O. BOX 2903, MINNEAPOLIS, MN, 55402-0903, US

(73) Assignee: Donaldson Company, Inc., Minneapolis, MN (US)

(21) Appl. No.: 10/506,929

(22) PCT Filed: Mar. 6, 2003
(86) PCT No.: PCT/US03/07036

Related U.S. Application Data
(60) Provisional application No. 60/362,595, filed on Mar. 8, 2002.

(51) Int. Cl. B01D 35/16

(52) U.S. Cl. 210/340

(57) ABSTRACT

Liquid filter arrangements are provided. In general, the liquid filter arrangements comprise a housing, a primary filter element, a secondary filter construction and a bypass valve arrangement. The components are arranged such that in normal operation, liquid flows through the primary filter element and then through the secondary filter construction; and, such that during bypass valve operation, flow circumvents the primary filter element and is directed through the secondary filter construction, before leaving the liquid filter arrangement. Both a disposable spin on embodiment and a serviceable cartridge embodiment are provided.

This application is being filed as a PCT International Patent Application in the name of Donaldson Company, Inc., a U.S. national corporation and resident, on 6 Mar. 2003, designating all countries except US, and claiming priority to U.S. Ser. No. 60/362,595 filed on 8 Mar. 2002.

### FIELD OF THE INVENTION

The present disclosure relates to liquid filter arrangements. The invention particularly concerns arrangements for use in filtering lube, fuel or hydraulic fluids, for various systems. The arrangements generally involve filter constructions in which, in addition to a main filter: a secondary filter structure is provided; and, a bypass flow arrangement is provided, to direct flow through the secondary filter, should the primary filter become adequately occluded.

### BACKGROUND OF THE INVENTION

In general; lubrication, fuel and hydraulic systems, utilize fluids that need to be filtered. For example, the lubrication oil in an engine, generally needs to be circulated through a filter system to ensure proper engine performance and life. As a result of the filtration, debris level within the circulating lubricating oil is controlled. Periodically such filter systems are generally serviced, by either cleaning or replacement.

Such filter systems generally utilize a primary filter, through which the liquid flow is directed, during equipment operation. As debris builds up on the primary filter, the pressure differential across the primary filter increases. In general, it is desirable to have a liquid filter system which includes a bypass system that allows flow to circumvent the primary filter, should the pressure differential across the primary filter increase beyond a desired amount. This will ensure that the fluid continues to circulate in the equipment, as needed, and reduces likelihood of damage to the equipment.

Space within engine systems and other equipment, is limited. It is important that a filtration system be efficiently designed with respect to ease of service and the amount of space that is taken up.

### SUMMARY OF THE INVENTION

According to the present disclosure, liquid filter arrangements are provided. In general the liquid filter arrangements include a housing, a primary filter element operably positioned within the housing, and secondary filter construction also operably positioned within the housing. Typically and preferably the primary filter element comprises an extension of media defining an open interior; and, preferably the secondary filter construction comprises a porous screen, with the porous screen positioned circumscribed by the extension of the media of the primary filter element. In general the preferred liquid filter arrangements include a bypass valve construction positioned to selectively permit liquid flow to bypass the primary filter element and to pass through the screen of the secondary filter construction, before exiting the liquid filter arrangement. In this manner the secondary filter construction operates: as a backup or secondary filter to the primary filter element in normal flow; and, as a bypass filter during bypass flow operation.

The preferred arrangement to the secondary filter construction comprises a metal wire screen supported by a porous support tube. Most preferably the porous support tube is a spiral wound, edge interlocked, metal support tube.

Two variations of the arrangement are provided: (1) a disposable system, in which a housing permanently encloses the various filter components and is serviced by complete removal and replacement; and, (2) a serviceable cartridge style system, in which the internal componentry of the housing can be serviced, for example by removing the primary filter element and replacing it.

In the detailed discussion and drawings, particular preferred embodiments to accomplish the above in efficient and desirable manners, are provided.

### BRIEF DESCRIPTION OF THE DRAWINGS

FIG. 1 is a side cross-sectional view of a first embodiment of a filter system embodying the principles of the present invention, shown attached to a filter head for a liquid filter operation; the embodiment shown being a disposable, spin-on, filter unit.

FIG. 2 is a cross-sectional view of the spin on filter unit used in the embodiment of FIG. 1.

FIG. 3 is a schematic exploded view of selected internal components of the spin on filter unit of FIG. 2.

FIG. 4 is an enlarged fragmentary schematic view of a bypass valve portion of the arrangement depicted in FIGS. 1-3.

FIG. 5 is a cross-sectional view of a second embodiment of a filter system according to the present invention; FIG. 5 depicting a serviceable filter unit having a serviceable internal component, mounted on a filter head.

FIG. 6 is an exploded, bottom perspective, view of selected components depicted in the embodiment of FIG. 5.

FIG. 7 is an exploded, top perspective, view of selected internal components of the arrangement depicted in FIG. 5.

FIG. 8 is a schematic cross-sectional view of selected internal componentry of the second embodiment depicted in FIGS. 5-7.

### DETAILED DESCRIPTION OF THE PREFERRED EMBODIMENT

### I. General Features and Principles of Operation

In general, the two depicted embodiments relate to features usable in lube, fuel and/or hydraulic (liquid) filter applications. The particular embodiments depicted, are especially well suited for use in lubrication applications, for engines. However, the techniques can be readily applied in alternate liquid systems, such as fuel or hydraulic fluid systems.

In general, the advantageous features characterized herein are shown as applicable in connection with both disposable filter arrangements and serviceable filter arrangements. In general, when used herein, the term “disposable filter arrangement” and variants thereof, is meant to refer to systems in which filter components are “permanently” contained within an outer housing; and, the outer housing is then mounted on a filter head for use. By “permanently” in this context it is meant that the internally received componentry cannot be removed from inside the housing without damage to the housing or some other portion of the system. In general, such filter systems are normally serviced by complete replacement of the housing with the contained internal componentry. The term “spin on” is often used to characterize such systems, because typically the method of mounting onto the filter head is through a threaded connection between the filter unit and the filter head.

Herein the term “serviceable” filter arrangement, is used to refer to an arrangement in which an outer housing section is attached to a filter head, and when the housing is removed, service access to internal filter componentry (for cleaning or replacement) within the housing is provided. With serviceable systems, typically internal, serviceable, filter element componentry is readily removable from the housing (once the housing has been separated from the filter head) without damage to the housing. Servicing generally involves replacement of some or all of the internally received filter componentry, without changing the outer housing. In typical instances, the outer housing is mounted onto the filter head, by threaded connection. Often “serviceable” filter arrangements are referred to as “cartridge filters”. In this context, the term “cartridge” is generally meant to refer to a particular replaceable or serviceable internal component, i.e., a primary filter element or cartridge.

In general, with either a disposable or serviceable system, features in preferred arrangements according to the present disclosure provide for the following:
1. a primary filter element received within (i.e., operably positioned in) a housing;
2. a configuration for filtering flow through the primary filter element, during normal operation;
3. a secondary filter structure operably positioned such that in normal flow after the liquid passes through the primary filter element, it is then directed through the secondary filter structure, before exiting the filter housing; and
4. a bypass system which operates:
   (a) to selectively allow bypass flow around (i.e., not through) the primary filter element should the pressure differential across the primary filter element exceed a selected value; and
   (b) to direct the bypass liquid in a selected path that ensures the bypass liquid is at least filtered by the secondary filter structure, before it can exit the filter housing, whenever the bypass valve is open.

Herein when it is said that a component is “operably positioned”, it is generally meant that the component is positioned appropriately to perform its function, in the characterized system.

The particular embodiments depicted herein indicate how such operation can be achieved in an efficient, effective and fairly easy to manufacture manner.

Although alternative arrangements using the principles characterized herein are possible, the particular preferred embodiments depicted provide for this in a convenient structure with at least the following characteristics:
1. In each case of preferred application, the primary filter element is cylindrical, and organized for flow from outside in;
2. In each case of preferred application, the secondary filter structure is contained within an open interior defined by the cylindrical primary filter element; and
3. In each case of preferred application, the bypass valve arrangement is positioned to direct flow, during bypass operation, around the media of the primary filter element and through the secondary filter structure.

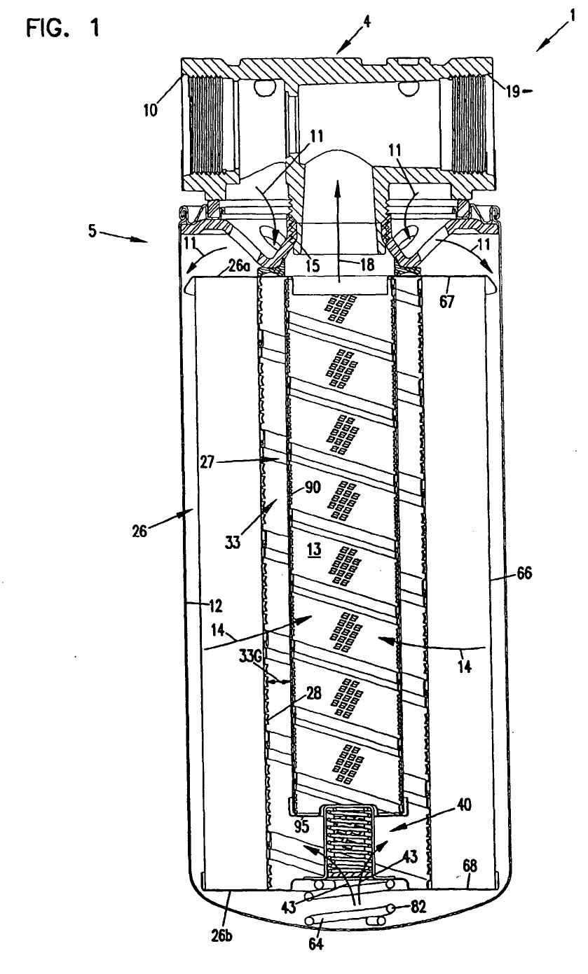

### II. An Embodiment of a Fully Disposable Spin On Style Filter Arrangement; FIGS. 1-4

Referring to FIG. 1, liquid filter assembly 1 is depicted in cross-section. The liquid filter assembly 1 generally comprises filter head 4 and replaceable (disposable) filter unit 5. In normal operation, filter head 4 would be permanently installed on equipment, in a line of flow of liquid such as lubrication liquid, hydraulic liquid or fuel liquid, to be filtered. Replaceable filter unit 5 would be oriented for service access, for periodic removal and disposal, and replacement with a new replacement, filter unit 5.

Referring to FIG. 1, liquid to be filtered: (a) enters filter head 4 through inlet 10 and is directed to the replacement unit 5 (as indicated by arrows 11) into unfiltered liquid region 12; (b) flows into clean liquid region 13 as indicated by arrows 14; (c) flows outwardly from replacement unit 5, into port 15 in the filter head 4, as shown by arrow 18; and, (d) then flows outwardly from filter head 4 through outlet 19.

During the normal flow operation as discussed above, for the depiction of FIG. 1, in traveling along the path of arrow 14, the liquid moves from region 12, a dirty or unfiltered liquid region, through primary filter element 26, for initial filtration, then through secondary filter arrangement 27, and then into clean liquid region 13.

For the particular embodiment depicted, the primary filter element 26 comprises a cylindrical filter defining a cylindrical, open interior 28; and, the secondary filter structure 27, is received within the open filter interior 28. In a particular embodiment shown, the actual filtration media for the secondary filter structure 27, preferably comprises a porous screen, for example a metal wire screen, that is completely enclosed within the open filter interior 28 of the primary filter element 26. By “completely enclosed” in this context it is meant that the media of the secondary filter structure 27: (a) is completely circumscribed by the primary filter element 26; and, (b) does not extend longitudinally (i.e., axially) outwardly from either end of the open cylindrical interior of the primary filter element 26. By “axially” in this context, it is meant there is no projection of media of the secondary filter structure 27 beyond axial ends 26a, 26b of primary filter element 26.

In the particular preferred embodiment shown, a liquid flow space 33, or intermediate flow chamber, is provided between the primary filter 26 and the secondary filter 27. That is, the two structures 26, 27 are spaced apart by a flow gap 33G.

The replacement filter unit 5 includes a bypass flow feature, as indicated above. Referring to FIG. 1, a bypass flow valve arrangement 40 is depicted. The bypass valve arrangement 40 is positioned such that should the pressure differential to liquid movement in the path of arrows 14, reach an opening pressure for the valve arrangement 40, liquid can bypass (or flow around) the primary filter 26 and move through the valve arrangement 40 in the direction of arrows 43, to eventually pass through the secondary filter construction 27 and eventually into clean liquid region 13. As a result, the configuration ensures that bypass liquid flow in the manner of arrows 43 will be filtered by the secondary filter unit 27 before exiting replacement filter unit 5, whenever the bypass valve is open.

In the preferred embodiment depicted, the bypass flow valve arrangement 40 is preferably “completely enclosed” within the open filter interior 28 of the primary filter element 26. By “completely enclosed” in this context, it is meant that preferably the portions of the bypass valve 40 that comprise the operating (movable) valve head and biasing member as described below, are: (a) completely circumscribed by the primary filter element 26; and, (b) do not project longitudinally (i.e., axially) outwardly from either end 26a, 26b of the primary filter element 26. Alternate configurations are possible. For example, in some applications the bypass valve arrangement 40 could be circumscribed by the primary filter element 26, but have a portion projecting axially beyond an end of the primary element 26. In still others, the bypass valve could be located not circumscribed by the primary element.

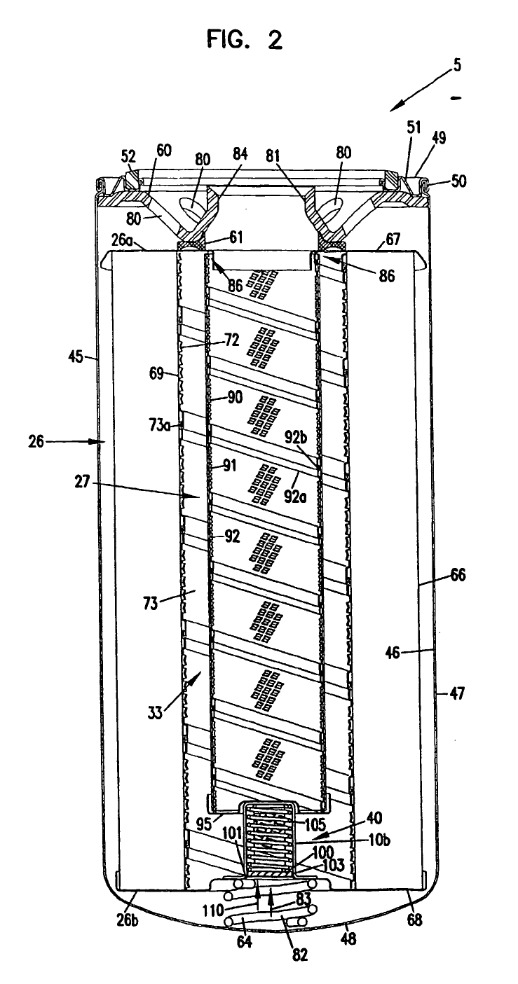

An example of structural detail for a typical, preferred, replacement filter unit 5 will be apparent from review of FIG. 2, which depicts the unit 5 separated from a filter head. The replacement filter unit 5 depicted in FIG. 2, would generally comprise those portions which, in typical use, would be removed and replaced during servicing of a liquid filter assembly 1 in accord with FIG. 1. The replacement filter unit 5 generally comprises an outer housing 45 defining an interior 46. The particular housing 45 depicted is cylindrical, although alternate constructions are possible. The outer housing 45 includes a closed end 48 and a side wall 47. The side wall 47 extends between closed end 48 and opposite end 49. At end 49, and secured via roll seam 50, the housing includes a support plate 51 for gasket or seal member 52. This gasket 52 provides for sealing against filter head 4, FIG. 1, when unit 5 is mounted. Support plate 51 also helps retain internal components within housing interior 46.

Included within interior 46 of housing 45 are the following general components:
1. top or end plate 60;
2. gasket 61;
3. primary filter element 26;
4. secondary filter construction 27;
5. bypass valve arrangement 40; and,
6. biasing member 64.

For the particular embodiment shown, the primary filter element 26, again, is generally cylindrical, typically comprising an extension of filter media 66 extending between first and second opposite end pieces comprising caps 67, 68.

The particular choice of media 66 for the primary filter element 26, is a matter of design choice dependent on such variables as: the specific liquid to be filtered and the anticipated contaminants; efficiency or other performance definitions required for the equipment involved; expected life time, etc. Preferred media will be fibrous. In general the specific choice of fibrous media 66 is not an issue related to the principles of the present invention as characterized in detail herein. It is anticipated that in typical applications the media will comprise a cylindrical extension of fibrous media, typically pleated, for example cellulose fiber media, synthetic fiber media, or media comprised of a mixture of cellulose fibers and synthetic fibers. Such a pleated media would often be provided with corrugations running perpendicular to the pleats, to ensure that the pleats are held open against collapse during operation. Alternate systems to pleated media, for example utilizing fiber wraps or other types of fiber structures, of course, are usable.

For the particular preferred embodiment shown, the end pieces or end caps 67, 68 are metal end caps (for example tin coated steel); and the cylindrical extension of filter media 66 is non-removably or non-releaseably potted to each, and extends therebetween. A typical potting compound useable for this would be plastisol, used in a conventional manner. Alternatively, the end caps 67, 68 could be molded. Herein, end cap or end piece 68, when used as shown in FIG. 2, will sometimes be referred to as the bypass valve end piece, since it includes an aperture as described below, which is selectively operable for bypass flow.

In preferred embodiments, FIG. 2, the cylindrical extension of filter media 66 is supported along its interior surface 69, by a porous or perforated support 72. For the particular arrangement shown, the porous support 72 comprises a tube 73, in this instance a spiral wound tube with an edge lock or seam 73a. The tube 73 extends between, and is secured to, end caps 67, 68. The porosity can be provided in a variety of manners, including for example holes or even small louvers cut in the metal. A typical useable material is the same as that described below for a support structure of the secondary filter arrangement 27, except appropriately sized. In general, the support structure 72 provides inhibition against collapse or other deformation of the filter media 66, during use.

Referring to FIG. 2., in general, end plate 60 includes inlet apertures 80, for liquid flow into replacement unit 5, and central liquid flow exit aperture 81. A seal is provided between the flow region of inlet apertures 80 and exit aperture 81 by gasket 61. A biasing pressure to maintain the seal, is provided by a biasing member 64, in this instance comprising spring 82, providing pressure in the direction of arrow 83, against end plate 68. In general, under the pressure of spring 82, gasket 61 is secured between end cap 67 and top or end plate 60. Thus, the top or end plate 60 operates to contain the primary filter element 26, the secondary filter structure 27 and the bypass valve arrangement 40 within housing 45. Referring to FIG. 1, the end plate 60 would typically be threaded in region 84 for mounting. The threads are not specifically depicted in FIG. 2.

In the embodiment depicted, the secondary filter construction 27 is also permanently secured to open end piece or end cap 67. In the instance depicted, this would be by potting into plastisol at region 86, FIG. 2. The preferred secondary filter construction 27 preferably comprises, as filter media, a porous screen 90, typically a metal wire screen, such as a woven wire screen. The particular choice of wire screen will be a matter of design choice, depending upon the particular application. In many instances, steel or treated steel wire screen will be usable, typically with wire size of 0.030 inches (about 0.762 mm) in diameter, or smaller. Typical wire sizes would be within the range of 0.002-0.030 inches, inclusive (about 0.051-0.762 mm). Many will use wires 0.015 inches (about 0.381 mm) in diameter or smaller. Overall screen thickness will typically and preferably be no more than 0.060 inches (about 1.524 mm), usually no more than 0.030 inches (about 0.762 mm). Typical wire population densities will be:
(a) in one direction 20 to 50 wires/inch (20 to 50 wires/25.4 mm);
(b) in a second, perpendicular direction, 100 to 250 wires per inch (100-250 wires per 25.4 mm).

A useable mesh would comprise, for example a plain Dutch weave mesh, of appropriate wire density for a desired level of performance.

In the instance of a lubrication filter for a large marine diesel engine, or an industrial diesel engine, such as a Detroit Diesel Series 4000 engine, it is anticipated that a metal wire mesh (plain Dutch weave) which provides for at least 50% efficiency in trapping debris or particles having a size of 80 microns or larger, and preferably at least 50% efficiency in trapping particles at least 65 microns or larger will be usable. Such meshes will generally be selected such that they provide 98.7% efficiency or more, trapping particles of about 120 microns or larger, and more preferably 98.7% efficiency trapping particles of 100 microns or larger.

In general, wire screens 90 of the type characterized above, are not adequately strong for preferred structural integrity during use in many filter systems as characterized. To provide the structural integrity, on a downstream side (typically inside) of the screen 90 is provided a support structure 91. The support structure 91 reinforces the downstream surface of the screen 90, against collapse. The particular support structure depicted is a porous tubular support structure 92. In general, the tubular support structure 92 is potted in, and extends between, end cap 67, and internal, closed, end cap 95, FIG. 2. The screen 90 is positioned around the tubular support structure 92, and can be secured in position at the same time as is the support tube 92. In some instances it may be desirable to make screen 90 slightly shorter than support tube 92, to facilitate assembly. The particular tubular support structure 92 depicted, comprises a spiral wound tube 92a with an edge interlock 92b. A variety of materials can be used. For example tin coated steel (for example a low carbon, cold rolled drawn quality special kilned steel) having a thickness of about 0.01-0.02 inches (about 0.25-0.51 mm) works well, in many applications. The tubes can be coiled from strips of a variety of sizes, for example strips about 1-3 inches (about 25.4-76.2 mm) typically about 1.77 inches (about 45 mm) wide can be used. Preferably the tube is made sufficiently porous by apertures, louvers or other pores therein. Typically, the tubular support should be provided of a construction that has about 10-40% open space, to have appropriate porosity for desirable function yet strength and integrity for performance. The porosity can be provided by holes in the tubular structure. However in general structures having apertures formed by stamping louvers in the metal, will be preferred, since: waste materials or scrap during the perforation process is avoided; and, the louver structure provides added strength to the system.

For the particular preferred arrangement depicted, the difference between the inside diameter of the primary filter 26, and the outside diameter of the secondary filter 27, is such that a flow gap 33G of at least 5 mm, and preferably a flow gap of at least about 10 mm, between the two, is provided. Typically, flow gaps on the order of 5 mm to 50 mm, inclusive, will be preferred.

Also in the preferred arrangement shown, the dimensions are selected such that the secondary filter construction 27 is completely circumscribed by, and is completely axially contained within, the primary filter construction 26.

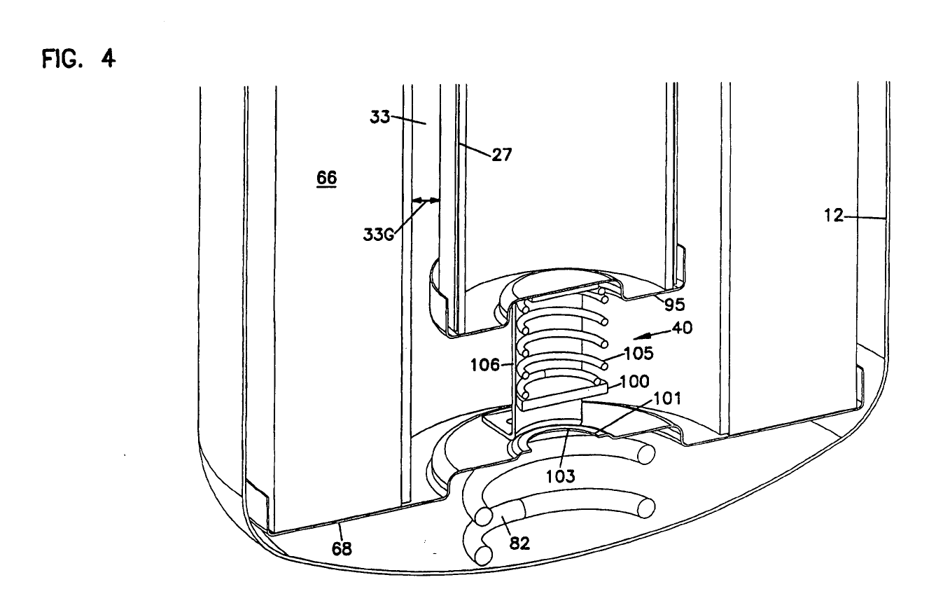

In the preferred embodiment depicted, FIG. 2, the bypass valve construction 40 comprises a valve head 100. The valve head 100 is shown seated against seat 101 (in covering relation to aperture 103) in end plate 68. The valve head 100 is secured in place under biasing force by biasing member 105. In general, the biasing valve arrangement 40 includes cage 106, which has openings therein, to allow fluid flow. Under sufficient compression in the direction of arrow 110, valve head 100 will be displaced from seat 101, by collapse of biasing member 105, for liquid flow into cage 106 and thus into flow region 33. The opening pressure for the biasing member of spring 105 is a matter of design choice, depending on the application and design preference. For a typical lube filter applications, it is anticipated that for biasing member 105 a spring will be selected that allows for opening of the valve arrangement 40 under a defined pressure differential thereacross, typically selected to be at a specified point within a range of 5-75 psi (about 0.34-5.17 Bar). In the instance of a large diesel engine such as a Detroit Diesel Series 4000 engine, the opening range for the bypass valve may be selected, for example, at 31-38 psi (about 2.14-2.62 Bar). An enlarged, fragmentary, view of the bypass valve construction 40 is shown in FIG. 4.

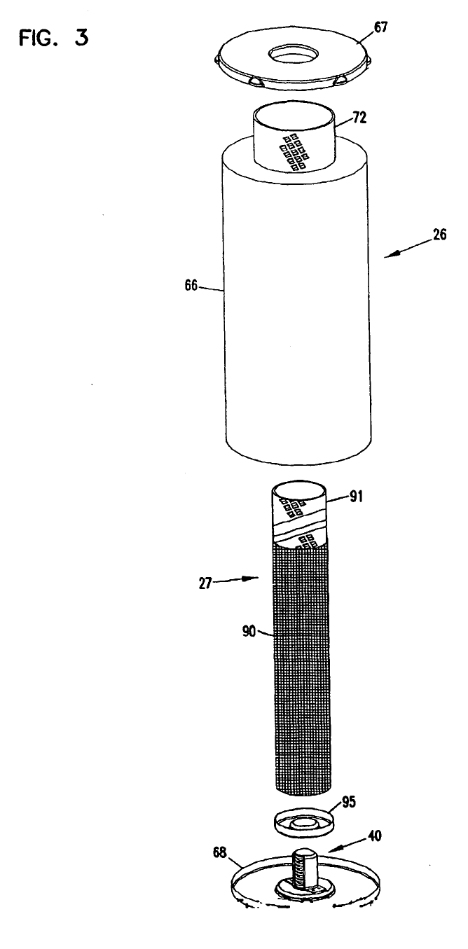

In FIG. 3, an exploded, schematic, depiction is provided indicating componentry between end caps 67 and 68. The componentry generally comprises: cylindrical, primary, filter media 66, the support structure 72 for the primary filter media, shown exploded partially (axially) out of the media 66; and the secondary filter construction 27, comprising screen 90 surrounding support structure 91; the support structure 91 being shown partially (axially) exploded out of the screen 90. Also, end cap 95 for the secondary filter construction 27 is shown, as well as bypass valve construction 40.

In FIG. 4, an enlarged fragmentary view of a portion of the filter unit 5 is depicted, illustrating among other things, the bypass valve construction 40 in a configuration with valve head 100 recessed away from seat 101, to allow bypass fluid flow into region 33.

Assembly of a unit in accord with the embodiment FIGS. 1-4, should now be apparent. In general, and referring to FIG. 3, a subassembly comprising the secondary support structure tube 91, inserted into a wire mesh screen 90, can be easily created. It is anticipated that mechanical interconnection between the two is not required, and a friction fit will be adequate. This subassembly could then be potted at one end to closed internal (second) end piece or cap 95, for example using plastisol.

A second subassembly comprising the primary filter media 66 with support tube 72 therein could be created. A first end of this could then be potted to first, open, end piece or end cap 67 using plastisol, along with potting of the remaining open of the subassembly comprising tube 91, mesh 90 and cap 95. The primary filter media 66 would be sized so that a second end would extend axially beyond the second, closed, end piece 95, to eventually encounter or become secured to the bypass valve end piece 68, and to enclose the following structure within volume 28: the bypass valve 40; and, the secondary support structure 27.

Another subassembly comprising cap 68 with bypass valve construction 40 thereon, could be created. This could then be secured to the remainder of the unit, for example using plastisol.

Turning to FIG. 2, this internal componentry would then placed within a housing 5, having a spring 82 therein. Gasket 61 and top plate 60 would then be positioned. Finally roll seam 50 would be created, and gasket 52 could be put in place.

In general, the techniques as characterized in the previous paragraph relating to manufacture, involve techniques well-known and established in connection with spin on style disposable filter elements for liquid filter applications, modified to accommodate the specific componentry characterized. Of course variations could be practiced, to achieve a similar, advantageous, structure.

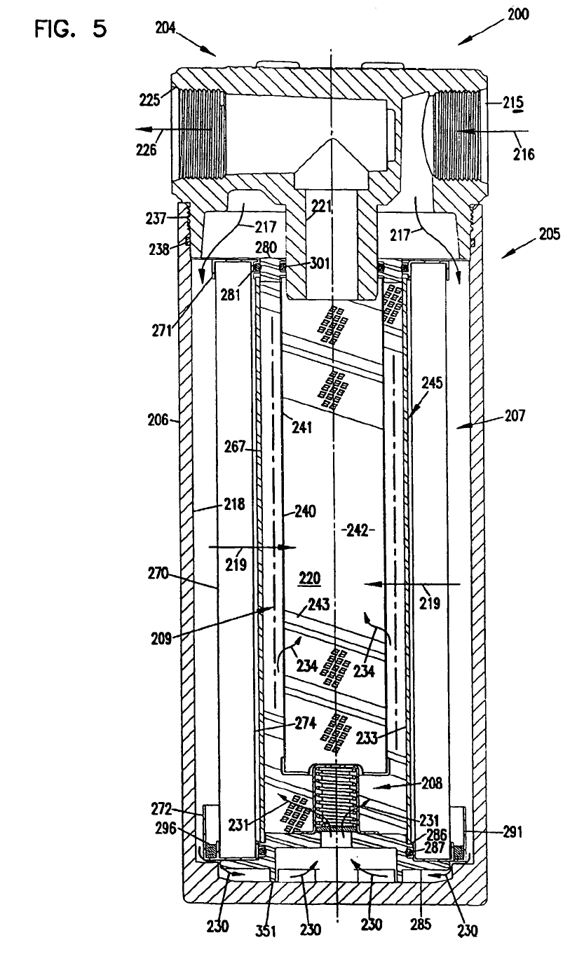

### III. A Serviceable Liquid Filter-Unit, FIGS. 5-8

As indicated previously, principles according to the present invention can be implemented in association with a serviceable filter unit. This will be understood by reference to the second embodiment of FIGS. 5-8. Referring to FIG. 5, reference numeral 200 generally designates a liquid filter assembly according to this second embodiment of the present invention. Liquid filter assembly 200 generally comprises filter head 204 and serviceable filter unit 205. The serviceable filter unit 205 generally comprises outer housing, bowl or can 206; and, internally received componentry including: a replaceable filter member 207; a bypass valve construction 208; and, a secondary filter construction 209. For the particular embodiment depicted, as will be understood from further detail, during a typical servicing, the serviceable filter unit 205 is separated from filter head 204, and only a portion of internally received componentry within the housing 206 is replaced. The particular replacement portion is generally the primary filter member or cartridge 207.

Still referring to FIG. 5, in operation liquid flow is generally as follows: liquid to be filtered enters the filter head 204 through inlet 215, as shown by arrow 216. Liquid then enters serviceable filter unit 205, as indicated generally at arrows 217, into dirty or unfiltered liquid region 218. Normal flow generally involves passage through primary element 207 in the direction of arrows 219, i.e., from outside to inside, to obtain normal primary filtering. Flow passage then is through secondary filter structure 209, into clean or filtered liquid region 220, and then outwardly from unit 205 into extension 221 of filter head 204. The liquid can then leave filter 204 through exit 225, as indicated by arrow 226.

Bypass flow circumventing the primary filter element 207, should a pressure differential thereacross attain a selected identified pressure, is provided by the bypass valve arrangement 208. In general, liquid flow to the bypass of arrangement 208 is indicated at arrows 230 and flow through the bypass valve arrangement 208 is indicated generally at arrows 231; which bypass flow will occur only when bypass valve arrangement 208 is open. Flow then extends into an intermediate flow region 233 positioned between primary element 207 and secondary filter structure 209. Flow then proceeds through the secondary filter structure 209 in the general direction of arrows 234 into region 220, for passage outwardly through filter head 204.

As thus far described, the basic filter operation and functional features of cartridge style liquid filter 200 are similar to those described in connection with the first embodiment for a disposable style system. It is anticipated that for a typical embodiment, the very same type of secondary filter unit 209 can be used, preferably comprising a porous metal wire screen 240 supported by a downstream support structure 241. The support structure 241 is preferably a tubular support structure 242, more preferably a spiral wound, edge interlocked, porous metal tube 243. In addition, analogous structure to that described for the first embodiment can be utilized for the bypass valve arrangement 208.

As indicated previously, the serviceable filter unit 205 is designed for servicing by replacement of selected internal componentry, as opposed to complete disposition of all material attached to the filter head. This will be apparent from the following descriptions.

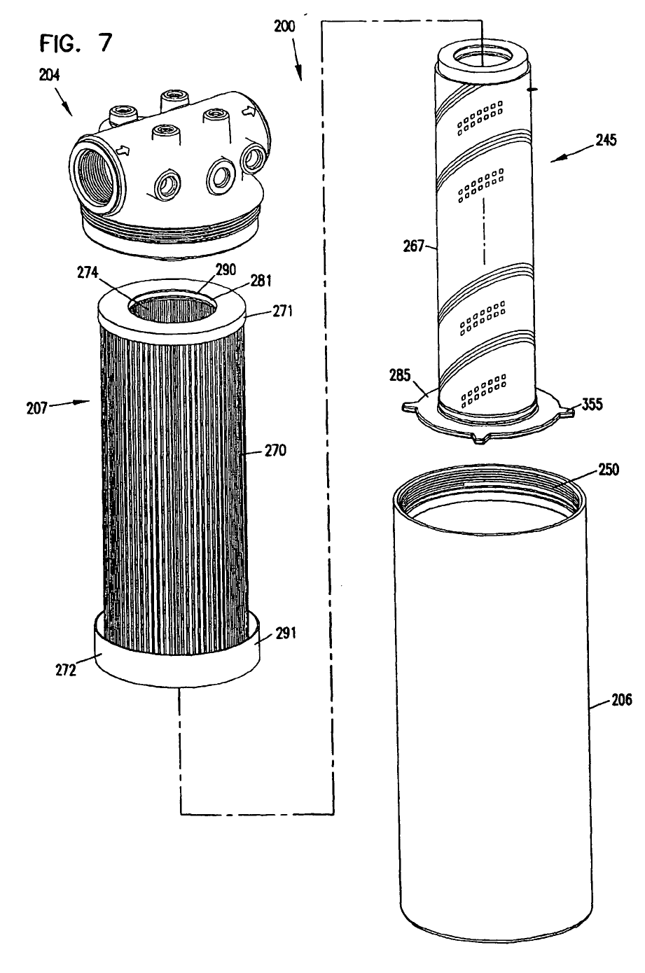

Referring still to FIG. 5, in general housing 206 is secured to filter head 204, in this instance by threaded engagement at 237. O-ring or gasket 238, positioned between threaded region 237 and internal region 218, provides for sealing at this location. During servicing, housing 206 would be separated from filter head 204 by disengaging thread engagement structure 237. At this point, access to internally received componentry is available through an end 250 of housing 206. This is shown in the exploded view, FIG. 7.

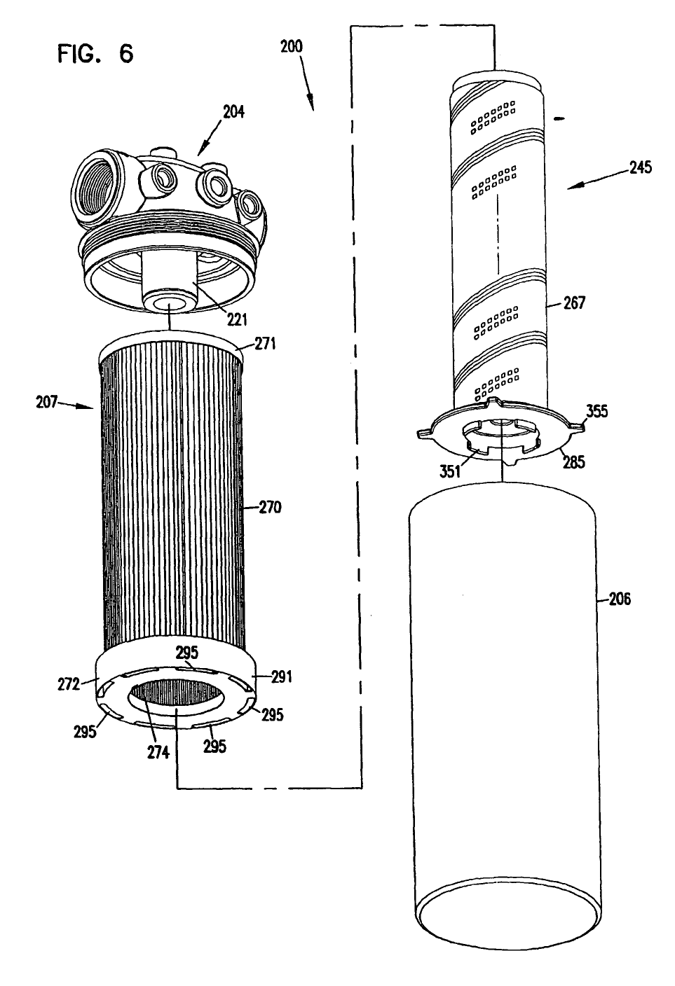

In general, inside of housing 206, are provided two subassemblies: the primary filter subassembly 207, FIG. 6; and, a subassembly 245 which in the preferred embodiment depicted, includes the following components:
1. an inner support 267 for the primary filter element; FIG. 5;
2. the secondary filter construction 209, FIG. 5; and,
3. the bypass valve construction 208, FIG. 5.

Still referring to FIG. 6, in general, the replacement or service part, comprises the primary filter subassembly 207. For the particular embodiment shown, the primary filter element subassembly 207 comprises an extension of media 270 provided in extension between a first open end piece 271 and a second open end piece 272. The particular media 270 depicted is a preferred cylindrical extension of pleated media, defining an internal volume 274.

Referring to FIG. 5, the first end cover piece 271 is shown as an open end piece non-permanently and sealingly engaging end piece 280 of the secondary filter construction 209, with O-ring 281 therebetween, to provide sealing. In addition, the second end piece 272 is shown as an open end piece non-permanently and sealingly engaging end piece 285 of the subassembly 245, in region 286 with O-ring 287 therebetween to provide a seal. A variety of friction fit, snap fit or interference fit constructions, can be used to accomplish the removable attachment of replacement part 207, to subassembly 245. In general, separating the two merely requires breaking this fit, typically with appropriate force applied longitudinally (i.e., axially), along the points of engagement.

A variety of different arrangements can be utilized for replacement part 207. The particular unit 207 depicted utilizes certain features characterized in WO 02/081052 published Oct. 17, 2002, the complete disclosure of which is incorporated hereby by reference. In general terms, end cap 271, of such a unit, would be molded on or potted to the media 270, with appropriate structure for engagement with the subassembly 245, and to interact with the O-ring. In addition, end piece 271 would be provided with an appropriate liquid flow aperture 290, FIG. 7 therein, for operation.

End cover 272, on the other hand, includes circumferential structure 291, FIG. 5, extending outwardly from the media 270 to allow for collection of contaminant, and contaminant containment, as the element 207 is lifted out of the housing 206 during servicing. In general this is accomplished by providing drain apertures 295, FIG. 6, in a bottom portion of cap 272, with filter media 296 extending thereover. Thus as the end cap 272 is drawn upwardly through liquid, when the element is replaced, the liquid can flow through the apertures, with contaminant being trapped. Again, this is described in detail in WO 02/081052, published Oct. 17, 2002. The use in the embodiment of FIGS. 5-8 is merely an example. Alternate systems for contaminant collection are described in U.S. Pat. No. 6,322,697, the complete disclosure of which is incorporated herein by reference.

It is noted the particular preferred replacement unit 207 depicted in the drawings, includes neither an internal liner nor an external liner or the media 270. In preferred systems, an internal support structure will be desirable, to provide appropriate product performance and protection against collapse or distortion of the media. It is preferable, however, that the internal liner structure not be removed with the replacement part, so as so facilitate efficiency and material disposal. To accommodate this, in the particular structure depicted an internal support structure for the primary element 207 is provided in the subassembly 245, i.e., in a portion of the serviceable filter unit 205 which is not removed and replaced during ordinary servicing.

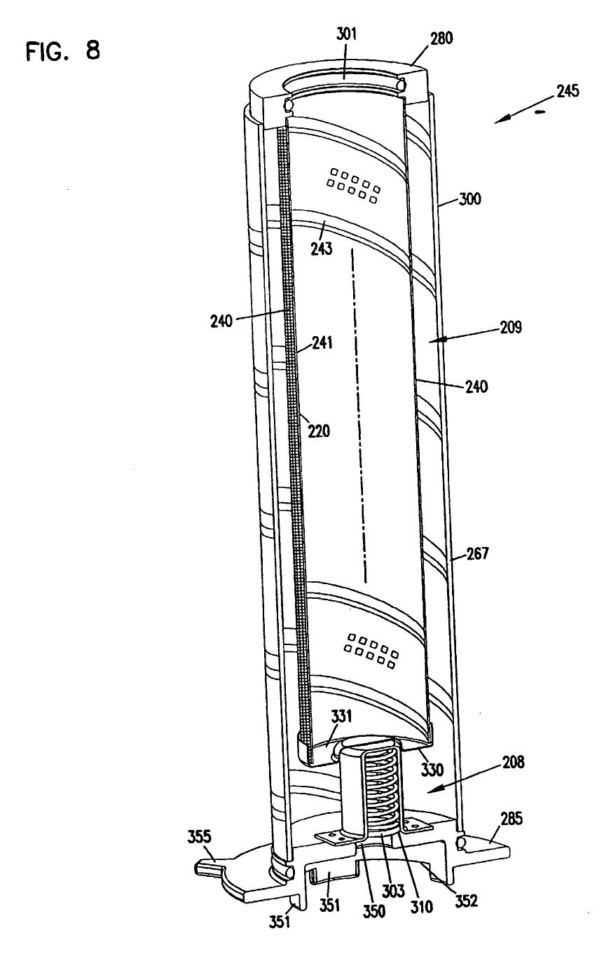

Attention is now directed to subassembly 245. Referring to FIG. 8, subassembly 245 generally comprises a porous outer support structure 300 extending between end pieces 280 and 285, and, internally received components comprising the bypass valve construction 208 and the secondary filter construction 209. O-ring 301 provides sealing to the filter head 204, FIG. 5.

Again, subassembly 245 comprises open end piece 280, opposite end piece (or bypass valve end piece) 285 and support structure 300 extending therebetween. The support structure 300 preferably comprises a porous tubular structure sized appropriately for, and positioned in the system when assembled, FIG. 5, to support the media 270 of the primary element 207, against collapse toward the downstream side (the inside in the embodiment shown). Specific contact between the support structure 300 and the media 270 is not required. In general a gap, for example, of up to 0.090 inches (about 2.29 mm), is acceptable.

Usable materials for support tube 300, include, for example, porous spiral wound, edge interlocked metal tubes of the type described for analogous componentry for the embodiment of FIGS. 1-4. The support tube 300 can be attached to end pieces 280, 285 by a variety of means including welding if metal pieces are used; potting; and/or molding.

Still referring to FIG. 8, subassembly 245 further includes secondary filter construction 209. Secondary filter construction 209 preferably comprises media 240, most preferably a porous screen, such as a (metal) wire mesh screen, supported along a downstream (inside) surface thereof by support structure 241, most preferably a spiral wound, edge interlocked, porous tubular support structure 243.

The secondary filter structure is generally supported in extension between first open end piece 280 and internal, second, closed end plate 330. End plate 330 generally encloses one end 331, of the clean liquid region 220 surrounded by the secondary filter structure 209. Attachment to second, closed, end plate 330 can be by a variety of ways, including for example potting with plastisol. Thus, in typical assembly, an appropriately sized support tube structure 241 would be provided with a woven wire screen 240 around it. This would then be potted to end cap 330, with an appropriate plastisol compound This unit could then be secured to end piece 280, for example by potting or welding. The outer support structure 300, for the primary filter element 207, could be attached to first, open, end piece 280 either simultaneously or separately, again by welding or potting.

The typical servicing of the serviceable arrangement depicted in FIGS. 5-8, will now be apparent. In general, during servicing housing 206 is separated from the filter in 204, using the threaded connection. The cartridge comprising the primary filter element 207 can be removed, by breaking the seals indicated 281 and 287, FIG. 5. A new primary filter 207 can then be installed, and the assembled unit 208 can be replaced onto the filter head 204. It is anticipated that in typical servicing operations, the inner support structure 300 for the primary filter element 207; the secondary filter construction 209; and the bypass valve 208 will not be modified, replaced, or serviced, except perhaps through a cleaning or similar operation.

Still referring to FIG. 8, bypass valve construction 208 may be generally as described above, in connection with FIGS. 1-4. In this instance, the valve head 303 is biased against a portion 310 of open end piece (or bypass valve end piece) 285, as a valve seat.

End piece 285 for the embodiment shown comprises a bypass valve end piece and includes the following features:
1. central aperture 350, for bypass fluid flow during opening of the bypass valve construction 208;
2. bottom projections 351 and spaces 352, which allow liquid flow to the central aperture 350, when the unit is stood on the bottom of the housing 206; and
3. radially directed prongs such as prongs 355.

The radially directed prongs 355 are generally oriented to engage structure (not shown) within the bottom of the housing 206, to ensure rotation of subassembly 247 relative to the filter head 204, when housing 206 is rotated onto or off of the filter head 204, via threads 237, FIG. 5. Alternate usable such structure is described, for example, in WO 02/081052, published Oct. 17, 2002, the complete disclosure of which is incorporated herein by reference.

The embodiment FIGS. 5-8, and the embodiment described in connection with FIGS. 1-4, use many analogous structural features for operation. In each instance the secondary filter media is preferably a porous wire mesh (preferably a metal wire mesh) preferably completely circumscribed by, and completely axially enclosed within, the primary media; and, the bypass valve construction is preferably positioned completely circumscribed by, and completely axially enclosed within, the primary filter media. Further the bypass valve construction is positioned to direct selected bypass flow not only around the media of the primary filter element, but also through the wire mesh of the secondary filter media, whenever the bypass valve is open.

It is apparent, then, that the techniques described herein have been applied to provide efficient effective filter operation, with a convenient easy to assemble arrangement. Further in each instance the removable housing contains the necessary components for: primary filter operation; secondary filter operation; and, bypass flow, without the need for additional add on equipment to the machinery involved.

Indeed, the following sample dimensions for a lube filter system, indicate how efficiently the techniques in the present invention provide for a desirable arrangement. The typical dimensions, not intended to be limiting, would be as follows:
1. Length of typical primary filter: on the order of 2-20 inches (about 5-51 cm), for example about 6-15 inches (about 15-38 cm); and a typical outside diameter of 2-6 inches (about 5-15 cm);
2. Typical O.D. for primary filter, about ⅛ to 1/2 inch (about 3-13 mm) smaller than the ID of the housing;
3. Typical length dimension for secondary filter: about 10-50 mm shorter than the primary filter.

A liquid filter arrangement comprises a housing; a primary filter element comprising media operably positioned within the housing; the primary filter element comprising an extension of media defining an internal volume; a secondary filter construction completely circumscribed by the extension of media of the primary filter element; the secondary filter construction comprising a porous screen operably positioned to filter liquid after the liquid has passed through the primary filter element and before the liquid has left the housing; and a bypass valve construction positioned to selectively permit liquid flow to bypass the primary filter element and to pass through the screen of the secondary filter construction, whenever the bypass valve construction is open. In some embodiments, the secondary filter construction comprises the porous screen supported by a support structure; the screen being spaced from the primary filter element to define an intermediate flow chamber therebetween. In some embodiments, the secondary filter construction comprises a wire screen supported by a porous support tube. In some embodiments, the porous support tube, of the secondary filter construction, comprises a spiral wound, edge interlocked, metal support tube. In some embodiments, the bypass valve construction is completely circumscribed by the cylindrical extension of media of the primary filter element. In some embodiments, a primary filter media support tube is positioned between the primary filter media and the porous screen of the secondary filter construction; the primary filter media support tube being positioned spaced from the porous screen to form the intermediate flow chamber therebetween. In some embodiments, the porous screen and the support structure, of the secondary filter construction, together define a tubular structure having first and second opposite ends; the first end of the tubular structure being secured to a first, open, end piece; and the second end of the tubular structure being secured to a second, closed, end piece. In some embodiments, the primary filter media support tube has first and second ends; the first end of the primary filter element support tube being secured to the first, open, end piece; and, the second end of the primary filter element support tube being spaced from, and extending axially beyond, the second, closed, end piece. In some embodiments, a bypass end piece has a bypass flow aperture therein; the second end of the primary filter element support tube being secured to the bypass flow end piece to enclose the secondary support structure within a volume defined by: the bypass flow end piece; the primary filter element support tube; and the first, open, end piece. In some embodiments, the bypass valve construction is positioned within the volume defined by: the bypass flow end piece; the primary filter element support tube; and the first, open end piece. In some embodiments, the cylindrical extension of media of primary filter element comprises an extension of pleated media having first and second, opposite ends. In some embodiments, the cylindrical extension of media has first and second, opposite, ends; the first end, of the extension of media being non-releaseably secured to the first, open, end piece; and the second end of the extension of pleated media being non-releaseably secured to the bypass valve end piece. In some embodiments, a top plate is positioned within the housing and permanently retaining the primary filter element, the secondary filter construction and the bypass valve construction in the housing, to form a disposable filter unit. In some embodiments, the primary filter element comprises the cylindrical extension of media extending between: a first, open, primary filter element end piece; and a second, open, primary filter element end piece; the first, open, primary filter element end piece being releaseably sealed to the first, open, end piece of the secondary filter construction; and the second, open, primary filter element end piece being releaseably sealed to the bypass value end piece. In some embodiments, the primary filter element comprises a removable and replaceable component in the housing.

A liquid filter arrangement comprises a primary filter element having a cylindrical configuration of fibrous media defining an open filter interior; a secondary filter element positioned within the open filter interior, the secondary filter element comprising a metal wire screen supported by a tubular support structure. In some embodiments, the wire screen comprises a wire size of 0.030 inches in diameter or smaller. In some embodiments, the wire screen has a wire density within the ranges of 20 to 50 per inch by 100 to 250 per inch. In some embodiments, the wire screen comprises a plain Dutch weave.

A method for filtering liquid comprises directing liquid through a primary filter element; and then directing the liquid through a porous screen completely circumscribed by the primary filter element; and opening a bypass valve to permit the liquid to bypass the primary filter element and to pass through the porous screen.

The above specification and examples provide a complete description of the manufacture and use of the composition of the invention. Since many embodiments of the invention can be made without departing from the spirit and scope of the invention, the invention resides in the claims hereinafter appended.

1-13. (canceled)

14. A liquid filter arrangement comprising:
(a) a housing;
(b) a primary filter element operably positioned within the housing; the primary filter element comprising:
(i) a cylindrical extension of pleated fibrous media defining an internal volume;
(ii) a primary filter media support tube circumscribed by the cylindrical extension of pleated fibrous media, the primary filter media support tube having a first end and a second end;
(c) a secondary filter construction completely circumscribed by the primary filter media support tube, the secondary filter construction operably positioned to filter liquid after the liquid has passed through the primary filter element and before the liquid has left the housing, the secondary filter construction comprising:
(i) a porous screen being spaced at least 5 mm from the primary filter media support tube to define an intermediate flow chamber therebetween; and
(ii) a porous support structure having a first end secured to a first, open, end piece, and a second end secured to a second, closed, end piece; the second end of the primary filter media support tube extending axially beyond the second, closed, end piece;
(d) a bypass valve construction selectively permitting liquid flow to bypass the primary filter element and to pass through the secondary filter construction, whenever the bypass valve construction is open; the bypass valve construction being completely circumscribed by the primary filter media support tube, the bypass valve construction including a bypass end piece having a bypass flow aperture therein;
(i) the second end of the primary filter media support tube secured to the bypass end piece to enclose the secondary filter construction within a volume defined by:
(A) the bypass end piece;
(B) the primary filter media support tube; and,
(C) the first, open, end piece;
(ii) with the bypass valve construction being positioned within the volume.

15. A liquid filter arrangement according to claim 14 wherein:
(a) the porous screen of the secondary filter construction comprises a wire screen.

16. A liquid filter arrangement according to claim 14 wherein:
(a) the porous support structure comprises a spiral wound, edge interlocked, metal support tube.

17. A liquid filter arrangement according to claim 14 wherein:
(a) the porous screen and the porous support structure, of the secondary filter construction, together define a tubular structure having first and second opposite ends:
(i) the first end of the tubular structure being secured to a first, open, end piece; and
(ii) the second end of the tubular structure being secured to a second, closed, end piece.

18. A liquid filter arrangement according to claim 17 wherein:
(a) the cylindrical extension of pleated fibrous media has first and second, opposite, ends;
(i) the first end being non-releaseably secured to the first, open, end piece; and
(ii) the second end being non-releaseably secured to the bypass end piece.

19. A liquid filter arrangement according to claim 18 including:
(a) a top plate positioned within the housing and permanently retaining the primary filter element, the secondary filter construction and the bypass valve construction in the housing, to form a disposable filter unit.

20. A liquid filter arrangement according to claim 17 wherein:
(a) the cylindrical extension of pleated fibrous media extends between a first, open, primary filter element end piece and a second, open, primary filter element end piece;
(i) the first, open, primary filter element end piece being releaseably sealed to the first, open, end piece of the secondary filter construction; and
(ii) the second, open, primary filter element end piece being releaseably sealed to the bypass end piece.

21. A liquid filter arrangement according to claim 20 wherein:
(a) the primary filter element comprises a removable and replaceable component in the housing.

22. A liquid filter arrangement according to claim 15 wherein:
(a) the wire screen comprises a wire size of 0.030 inches in diameter or smaller.

23. A liquid filter arrangement according to claim 15 wherein:
(a) the wire screen has a wire density within the ranges of 20 to 50 per inch by 100 to 250 per inch.

24. A liquid filter arrangement according to claim 15 wherein:
(a) the wire screen comprises a plain Dutch weave.

25. A method for filtering liquid with a filter arrangement; the filter arrangement including: a housing; a primary filter element operably positioned within the housing; the primary filter element comprising: (i) a cylindrical extension of pleated fibrous media defining an internal volume; (ii) a primary filter media support tube circumscribed by the cylindrical extension of pleated fibrous media, the primary filter media support tube having a first end and a second end; a secondary filter construction completely circumscribed by the primary filter media support tube, the secondary filter construction operably positioned to filter liquid after the liquid has passed through the primary filter element and before the liquid has left the housing, the secondary filter construction comprising: (i) a porous screen being spaced at least 5 mm from the primary filter media support tube to define an intermediate flow chamber therebetween; and (ii) a porous support structure having a first end secured to a first, open, end piece, and a second end secured to a second, closed, end piece; the second end of the primary filter media support tube extending axially beyond the second, closed, end piece; a bypass valve construction selectively permitting liquid flow to bypass the primary filter element and to pass through the secondary filter construction, whenever the bypass valve construction is open; the bypass valve construction being completely circumscribed by the primary filter media support tube, the bypass valve construction including a bypass end piece having a bypass flow aperture therein; the second end of the primary filter media support tube secured to the bypass end piece to enclose the secondary filter construction within a volume defined by: (A) the bypass end piece; (B) the primary filter media support tube; and (C) the first, open end piece; with the bypass valve construction being positioned within the volume;
the method comprising:
(a) directing liquid through the primary filter element; and then
(b) directing the liquid through the secondary filter element.

26. A method for filtering liquid according to claim 24, and further comprising:
(c) opening a bypass valve to permit the liquid to bypass the primary filter element and to pass through the porous screen.
